(19) United States
(12) Patent Application Publication
(10) Pub. No.: US 2024/0226611 A9
(43) Pub. Date: Jul. 11, 2024

(54) Fire Escape Tube Device

(71) Applicant: John Keogh, Corpus Christi, TX (US)

(72) Inventor: John Keogh, Corpus Christi, TX (US)

(21) Appl. No.: 18/184,196

(22) Filed: Mar. 15, 2023

Related U.S. Application Data
(60) Provisional application No. 63/418,206, filed on Oct. 21, 2022.

(51) Int. Cl. A62B 1/20

(52) U.S. Cl. CPC A62B 1/20

(57) ABSTRACT

The present invention relates to a novel fire escape device. The device is a clear, heavy plastic tube that acts as a fire escape. The tube extends down the outside of a building and comprises a plurality of foot platforms throughout, varying depending on the number of floors. The floor platform would be attached to a cable that runs from the top of the building to the bottom, utilizing a large weight-resistant wheel or gear to maintain continuous operation without electricity or other sources of power. These moving foot platforms would operate like an elevator, transporting people to the bottom of the building in an emergency. Firefights can also utilize the device to help fight the fire and guide people out of the building safely.

### CROSS-REFERENCE TO RELATED APPLICATION

The present application claims priority to, and the benefit of, U.S. Provisional Application No. 63/418,206, which was filed on Oct. 21, 2022, and is incorporated herein by reference in its entirety.

### FIELD OF THE INVENTION

The present invention relates generally to the field of fire escape devices. More specifically, the present invention relates to an exterior fire escape device constructed like a tube with an internal elevator. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in fire escape devices. Generally, large apartment buildings, office buildings, and other commercial buildings may have numerous inhabitants, making it difficult for everyone to escape during a building fire. Fire escapes can be helpful but still not enough to ensure every person makes it out of the building safely. Thus, serious injury and death can occur due to building fires.

Accordingly, a need remains for a fire escape that safely encloses escaping persons from flames, heat, smoke, gas, and falling debris so that it is safer than an open fire escape on which escaping persons are exposed to all fire hazards. Further, a fire escape is needed which is particularly suitable for tall buildings having many floors, and which more quickly delivers escaping persons to a street level. Still another object of the invention is to provide a fire escape that is less frightening to little children and others because they cannot see the frightening distance from a great height down toward the ground.

Therefore, there exists a long-felt need in the art for a fire escape device that provides users with an exterior fire escape system constructed like a tube with an internal elevator. There is also a long-felt need in the art for a fire escape device that includes foot platforms attached to a cable and pulley system that constantly rotates to ensure people can escape a burning building. Further, there is a long-felt need in the art for a fire escape device that utilizes fireproof materials to maximize safety for anyone stepping into the escape system. Moreover, there is a long-felt need in the art for a device that operates via counterweights on gears and wheels with resistance to maintain operation without any electricity. Further, there is a long-felt need in the art for a fire escape device that comprises a clear, heavy plastic tube. Finally, there is a long-felt need in the art for a fire escape device that can be utilized by firefighters to help fight a fire.

The subject matter disclosed and claimed herein, in one embodiment thereof, comprises a fire escape device. The device is a clear, heavy plastic tube that acts as a fire escape. The tube extends down the outside of a building and comprises a plurality of foot platforms throughout, varying depending on the number of floors. The floor platform would be attached to a cable that runs from the top of the building to the bottom, utilizing a large weight-resistant wheel or gear to maintain continuous operation without electricity or other sources of power. These moving foot platforms would operate like an elevator, transporting people to the bottom of the building in an emergency. Firefighters can also utilize the device to help fight a fire and guide people out of a building safely.

In this manner, the fire escape device of the present invention accomplishes all of the foregoing objectives and provides users with a device that helps people escape a building fire. The device is a plastic tube that acts as a fire escape. The device operates without electricity or other sources of power.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fire escape device. The device is a clear, heavy plastic tube that acts as a fire escape. The tube extends down the outside of a building and comprises a plurality of foot platforms throughout, varying depending on the number of floors. The plurality of floor platform components would be attached to a cable that runs from the top of the building to the bottom, utilizing a pulley, gears, and/or counterweights to maintain continuous operation without electricity or other sources of power. These moving foot platforms would operate like an elevator, transporting people to the bottom of the building in an emergency. Firefighters can also utilize the device to be transported into the building to help fight a fire and guide people out of a building safely.

The disclosed invention relates to improvements in fire escapes for high rises and large buildings and has reference to mechanisms which will be automatic in their action and will be safe and durable.

In one embodiment, the fire escape device comprises an upright cylindrical tube that contains a plurality of foot platforms extending throughout its length. The upper end of the tube is covered by a fireproof roof made of steel or the like. The tube is likewise made of a clear, heavy thermoplastic material that is also fireproof to protect the occupant from the flames and heat from the building.

In one embodiment, the tube can be installed either within the interior of a building, or else it may be permanently erected adjacent an outer side thereof. Further, a series of access doorways are provided along the side of the tube, each doorway communicating with one of the building floors so that persons on all floors have access to the tube for escape.

Further, leading into the tube from a nearby window of each floor of the building is an inclined opening into which the person desiring to escape from the building places himself or herself onto a foot platform, preferably in an upright, standing position.

In one embodiment, each doorway is fitted with an upwardly pivotable door so that it automatically closes by gravity force when a person rushes into the fire escape device without thinking or consideration of the inadvisability of the doorways being left open during a fire, so that flames, suffocating gas, and burning debris do not enter. Each doorway is low near a floor so a person can find it easier if clouds of smoke fill the upper air layers.

In one embodiment, the tube diameter may be about six foot in diameter, or even larger if heavier traffic is possible, such as in very tall buildings. Typically, it would be made in section lengths secured together via flanges and screws, etc.

As the first person to enter the tube may come from a window at any one of the floors of the building, it is also necessary that all of the doors leading into the tube shall be primarily unlocked. Users will step onto the foot platform component and will slide down by the counterweight, thereby slowly lowering the person to the exit door.

In one embodiment, the tube comprises an exit doorway at street level (i.e., bottom of the tube) which would permit escaped persons to leave the fire escape device. The exit doorway would normally be locked from the inside so to prevent unauthorized persons from the street to enter and thus, enter the building. However, during an escape from a burning building, a first person or child reaching the exit door automatically opens the exit door by bumping against a latch mechanism.

In one embodiment, the latch mechanism is a pivotable pin supported on the exit door. Further, a leaf spring secured at one end to a lever is pivotally attached at its other end to a bar so that the bar is pushed up when the lever is pushed. The lifting bar thus slips out of the latch, thus allowing the exit door to swing open outward on its hinges.

In one embodiment, a plurality of electric lights for illuminating the fire escape device interior may be provided to automatically turn on when a person enters the fire escape device.

In one embodiment, a cable or other connecting element, such as a transmission chain, will extend from the ground to the topmost story of the building and will terminate at the top and bottom with a pulley and cable system.

Mounted on the top and bottom is the pulley and cable system, secured to the top and the bottom of the building, the device is secured to. Further, at suitable intervals, a foot platform component is secured to the cable at an end or the middle of the foot platform. The cable can be connected to a foot platform component via, for instance, a pin, a screw, or a metal collet connected to the center part of the foot platform component or secured to an end of the foot platform component. In one embodiment, the metal collet or screw/pin would crimp onto the cable to hold the foot platform component in place on the cable.

In one embodiment, people are moved on the foot platform components secured to the cable, which forms a continuous moving track. The foot platform components are usually connected to each other with a cable or other transmission chain, which is pulled for movement or moved via counterweights. The track comprises an upper track section, (i.e., a conveyor part), on which the passengers can stand, and a lower track section, (i.e., a return part), the foot platform components of the return part move below the foot platform components in the conveyor part and in the opposite direction in relation to them. Both ends of the conveyor comprise an arrangement for turning the direction of the foot platform components and for moving the foot platform components between the conveyor part and the return part. When moving a foot platform component between the conveyor part and the return part, it is guided to travel a curved trajectory until its direction of movement has turned to the desired direction. This is most generally done such that a diverting pulley turns the direction of movement of the transmission chain or cable, to which chain each foot platform component is fixed, in which case the pallet undergoes a path of movement according to a circular curve of the direction of movement in the direction change area.

Both ends of the conveyor comprise counterweights which act to give a mechanical advantage in the opposite direction the user is pulling. The counterweights can be any suitable weights as is known in the art. In one embodiment, the counterweights can be a large weight-resistant wheel and/or gear, or any other suitable counterweights as are known in the art.

In one embodiment, a transmission chain or cable and its diverting pulley produce some of the forces needed for guiding and supporting a foot platform component. In addition to this, a foot platform component generally comprises a guide part, which moves to be guided by a guide rail part in some phase of the direction change, (i.e., while it is on the curved trajectory or immediately afterwards after having turned onto a flat section).

Accordingly, in use, escaping persons would stand on a foot platform component made of a suitable material for comfort and move the platform down the tube. It will be observed that the foot platform components travel down one side of the cable and up the other cable in a continuous circuit, and upon these foot platform components, the people to be liberated from the burning building take their positions and are carried down by gravity and are discharged automatically at the bottom. Thus, the foot platform component is depressed by the weight of a person standing on it. Further, to prevent too rapid a descent of the foot platform component, a counterweight, such as a large weighted-resistant wheel and/or gear, is secured to the pulley and cable system to control the downward descent of the foot platform components. When the first person to descend in the above-described foot platform component reaches the bottom, the foot platform component then continues upward.

In yet another embodiment, the fire escape device comprises a plurality of indicia.

In yet another embodiment, a method of escaping a building fire from a large building is disclosed. The method includes the steps of providing a fire escape device comprising a tube with a plurality of foot platforms throughout, connected via a cable and pulley system and a large weight-resistant wheel. The method also comprises entering the tube and stepping onto one of the foot platforms. Further, the method comprises descending automatically via the cable and pulley system, such that the large weight-resistant wheel acts to slow the rate of descent. Finally, the method comprises exiting the tube once the foot platform has reached the bottom of the building.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the fire escape device of the present invention showing a user escaping a building fire in accordance with the disclosed architecture;

FIG. 2 illustrates a front perspective view of one embodiment of the fire escape device of the present invention showing the device installed on a side of a building in accordance with the disclosed architecture;

FIG. 3 illustrates a front perspective view of one embodiment of the fire escape device of the present invention showing firefighters utilizing the device in accordance with the disclosed architecture;

FIG. 4 illustrates a front perspective view of one embodiment of the fire escape device of the present invention showing the device in use in accordance with the disclosed architecture;

FIG. 5 illustrates a top perspective view of one embodiment of the fire escape device of the present invention showing the tube of the device in accordance with the disclosed architecture; and

FIG. 6 illustrates a flowchart showing the method of escaping a building fire from a large building in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a fire escape device that provides users with an exterior fire escape system constructed like a tube with an internal elevator. There is also a long-felt need in the art for a fire escape device that includes foot platforms attached to a cable and pulley system that constantly rotates to ensure people can escape a burning building. Further, there is a long-felt need in the art for a fire escape device that utilizes fireproof materials to maximize safety for anyone stepping into the escape system. Moreover, there is a long-felt need in the art for a device that operates via counterweights on gears and wheels with resistance to maintain operation without any electricity. Further, there is a long-felt need in the art for a fire escape device that comprises a clear, heavy plastic tube. Finally, there is a long-felt need in the art for a fire escape device that can be utilized by firefighters to help fight the fire.

The present invention, in one exemplary embodiment, is a novel fire escape device. The device is a clear, heavy plastic tube that acts as a fire escape. The tube extends down the outside of a building and comprises a plurality of foot platforms throughout, varying depending on the number of floors. The floor platform would be attached to a cable that runs from the top of the building to the bottom, utilizing a large weight-resistant wheel or gear to maintain continuous operation without electricity or other sources of power. These moving foot platforms would operate like an elevator, transporting people to the bottom of the building in an emergency. Firefighters can also utilize the device to help fight the fire and guide people out of the building safely. The present invention also includes a novel method of escaping a fire in a large building. The method includes the steps of providing a fire escape device comprising a tube with a plurality of foot platforms throughout, connected via a cable and pulley system and a large weight-resistant wheel. The method also comprises entering the tube and stepping onto one of the foot platforms. Further, the method comprises descending automatically via the cable and pulley system, such that the large weight-resistant wheel acts to slow the rate of descent. Finally, the method comprises exiting the tube once the foot platform has reached the bottom of the building.

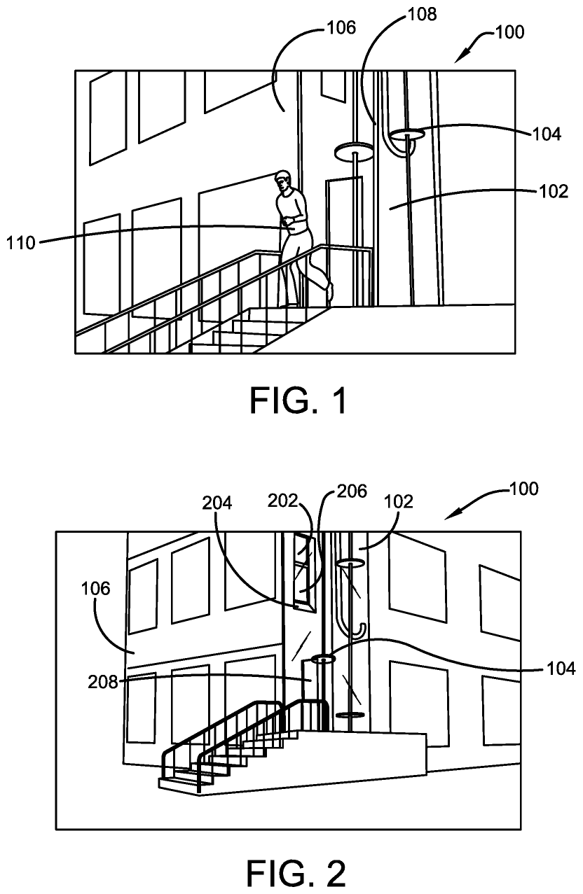

Referring initially to the drawings, FIG. 1 illustrates a perspective view of one embodiment of the fire escape device 100 of the present invention. In the present embodiment, the fire escape device 100 is an improved fire escape device 100 that allows a user to escape a burning building quickly and efficiently. The fire escape device 100 comprises a tube component 102 with a plurality of foot platform components 104 distributed throughout. Specifically, the device 100 is a clear, heavy plastic tube 102 that acts as a fire escape. The tube 102 extends down the outside of a building 106 and comprises a plurality of foot platform components 104 throughout, varying depending on the number of floors. The plurality of floor platform components 104 would be attached to a cable 108 that runs from the top of the building 106 to the bottom, utilizing pullies, gears, and/or counterweights, etc., to maintain continuous operation without electricity or other sources of power. These moving foot platform components 104 would operate like an elevator, transporting people 110 to the bottom of the building 106 in an emergency. Firefighters 300 can also utilize the device 100 to be transported into the building 106 to help fight the fire and guide people 110 safely out of a building 106.

The disclosed invention relates to improvements in fire escapes for high rises and large buildings and has reference to mechanisms which will be automatic in their action and will be safe and durable.

As shown in FIG. 2, the fire escape device 100 comprises an upright cylindrical tube component 102 that contains a plurality of foot platform components 104 extending throughout its length. The upper end of the tube 102 is covered by a fireproof roof 200 made of steel or the like. The tube 102 is likewise made of a clear, heavy thermoplastic material that is also fireproof to protect occupants from the flames and heat from the building 106.

In one embodiment, the tube 102 can be installed either within the interior of a building 106, or it may be permanently erected adjacent an outer side thereof. Further, a series of access doorways 202 are provided along the side of the tube 102, each access doorway 202 communicating with one of the building floors so that persons 110 on all floors have access to the tube 102 for escape.

Further, leading into the tube 102 from a nearby window of each floor of the building 106 is an inclined opening 204, into which the person 110 desiring to escape from the building 106 places himself or herself and onto a foot platform component 104, preferably in an upright, standing position.

Additionally, each access doorway 202 is fitted with an upwardly pivotable door 206 so that it automatically closes by gravity force when a person 110 rushes into the fire escape device 100 without thinking or consideration of the inadvisability of the access doorways 202 being left open during a fire, so that flames, suffocating gas, and burning debris do not enter. Each access doorway 202 is low near a floor so a person 110 can find it easier if clouds of smoke fill the upper air layers.

In one embodiment, the tube 102 diameter may be about six feet, or even larger if heavier traffic is possible, such as in very tall buildings 106. Typically, it would be made in section lengths secured together via flanges, screws, etc.

As the first person 110 to enter the tube 102 may come from a window at any one of the floors of the building 106, it is also necessary that all of the access doors 202 leading into the tube 102 shall be primarily unlocked. Users 110 will step onto the foot platform component 104 which will slide down the tube by the counterweights, thereby slowly lowering users 110 to an exit door 208 at ground level.

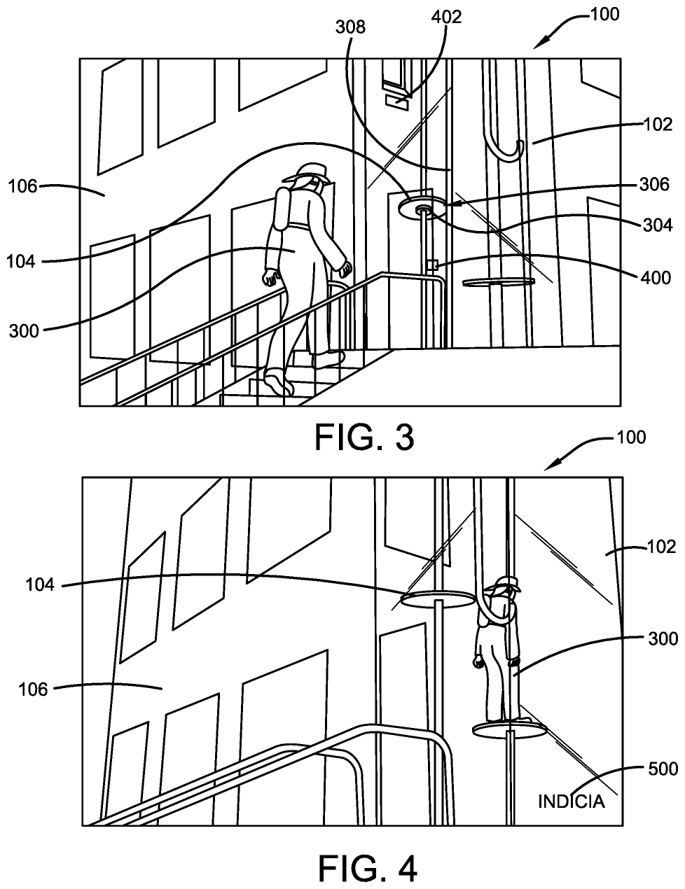

As shown in FIG. 3, a cable 108 or other connecting element, such as a transmission chain, will extend from the ground to the topmost story of the building 106 and will terminate at top and bottom with a pulley and cable system 302.

Mounted on the top and bottom is the pulley and cable system 302, secured to the top and the bottom of the building 106 the device 100 is secured to. Further, at suitable intervals, a foot platform component 104 is secured to the cable 108 at an end or the middle of the foot platform component 104. The cable 108 can be connected to a foot platform component 104 via, for instance, a pin, a screw, or metal collet 304 connected to the center part 306 of the foot platform component 104 or secured to an end of the foot platform component 104. In one embodiment, the metal collet 304 or screws/pin would crimp onto the cable 108 to hold the foot platform component 104 in place on the cable 108.

In one embodiment, people 110 are moved on the foot platform components 104 secured to the cable 108, which forms a continuous moving track 308. The foot platform components 104 are usually connected to each other with a cable 108 or other transmission chain, which is pulled for movement or moved via counterweights 310. The track 308 comprises an upper track section (i.e., a conveyor part 312) on which the passengers 110 can stand, and a lower track section (i.e., a return part 314), wherein the foot platform components 104 of the return part 314 move below the foot platform components 104 in the conveyor part 312 and in the opposite direction in relation to them. Both ends of the track 308 comprise an arrangement for turning the direction of the foot platform components 104 and for moving the foot platform components 104 between the conveyor part 312 and the return part 314. When moving a foot platform component 104 between the conveyor part 312 and the return part 314, it is guided to travel a curved trajectory until its direction of movement has turned to the desired direction. This is most generally done such that a diverting pulley 302 turns the direction of movement of the transmission chain or cable 108 to which chain each foot platform component 104 is fixed, in which case the foot platform component 104 undergoes a path of movement according to a circular curve of the direction of movement in the direction change area.

Both ends of the track 308 comprise counterweights 310 that act to give a mechanical advantage opposite in the direction the user 110 is pulling. The counterweights 310 can be any suitable weights as is known in the art. In one embodiment, the counterweights 310 can be a large weight-resistant wheel and/or gear, or any other suitable counterweights 310 as is known in the art.

In one embodiment, a transmission chain or cable 108 and its diverting pulley 302 produce some of the force needed for guiding and supporting a foot platform component 104. In addition to this, a foot platform component 104 generally comprises a guide part 316, which moves to be guided by a guide rail part 318 in some phase of the direction change (i.e., while it is on the curved trajectory or immediately afterwards after having turned onto a flat section).

As shown in FIG. 4, the tube 102 comprises an exit doorway 208 at street level (i.e., bottom of the tube 102) which would permit escaped persons 110 to leave the fire escape device 100. The exit doorway 208 would normally be locked from the inside so to prevent unauthorized persons from the street to enter and thus, enter the building 106. However, during an escape from a burning building, the first person or child reaching the exit door 208 automatically opens the exit door 208 by bumping against a latch mechanism 400.

In one embodiment, the latch mechanism 400 is a pivotable pin supported on the exit door 208. Further, a leaf spring secured at one end to a lever is pivotally attached at its other end to a bar so that the bar is pushed up when the lever is pushed. The lifting bar thus slips out of the latch allowing the exit door 208 to swing open outward on its hinges.

In another embodiment, a plurality of electric lights 402 for illuminating the fire escape device 100 interior may be provided to automatically turn on when a person 110 enters the fire escape device 100.

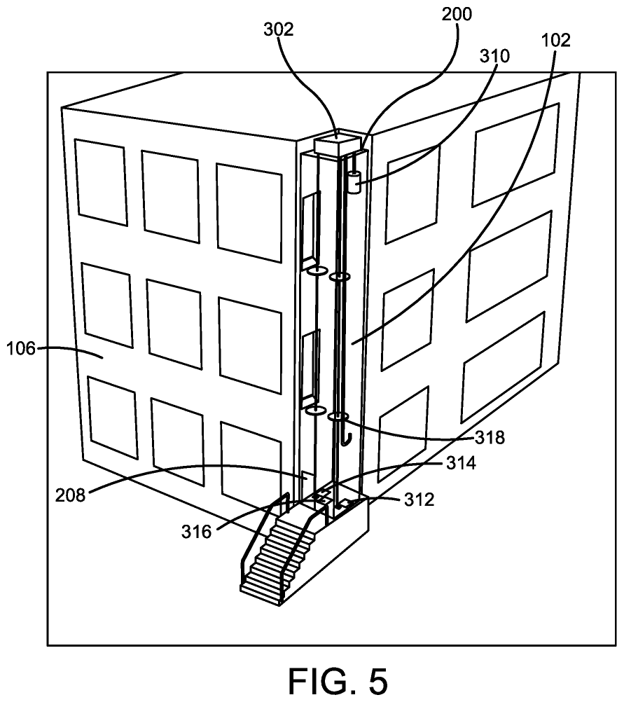

As shown in FIG. 5, in use, escaping persons would stand on a foot platform component 104 made of a suitable material for comfort and move it down the tube 102. It will be observed that the foot platform components 104 travel down one side of the cable 108 and up the other cable 108 in a continuous circuit, and upon these foot platform components 104 the people 110 to be liberated from the burning building 106 take their position and are carried down by gravity and are discharged automatically at the bottom. Thus, the foot platform component 104 is depressed by the weight of a person 110 standing on it. Further, to prevent too rapid a descent of the foot platform component 104, a counterweight 310, such as a large weighted-resistant wheel and/or gear, is secured to the pulley and cable system 302 to control the downward descent of the foot platform components 104. When the first person 110 to descend in the above-described foot platform component 104 reaches the bottom, the foot platform component 104 then continues upward.

In yet another embodiment, the fire escape device 100 comprises a plurality of indicia 500. The tube 102 of the device 100 may include advertising, trademark, other letters, designs, or characters, printed, painted, stamped, or integrated into the tube 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be fire, safety, or brand related.

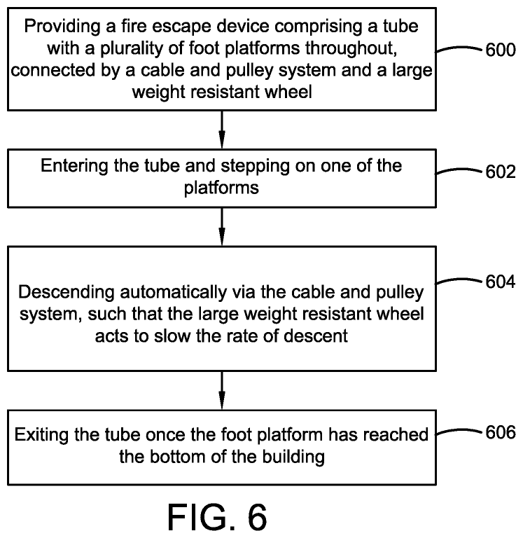

FIG. 6 illustrates a flowchart of the method of escaping a fire in a large building. The method includes the steps of at 600, providing a fire escape device comprising a tube with a plurality of foot platforms throughout, connected via a cable and pulley system and a large weight-resistant wheel. The method also comprises at 602, entering the tube and stepping onto one of the foot platforms. Further, the method comprises at 604, descending automatically via the cable and pulley system, such that the large weight-resistant wheel acts to slow the rate of descent. Finally, the method comprises at 606, exiting the tube once the foot platform has reached the bottom of the building.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “fire escape device”, “fire device”, and “device” are interchangeable and refer to the fire escape device 100 of the present invention.

Notwithstanding the foregoing, the fire escape device 100 of the present invention can be of any suitable size and configuration as is known in the art without affecting the overall concept of the invention, provided that it accomplishes the above-stated objectives. One of ordinary skill in the art will appreciate that the fire escape device 100 as shown in FIGS. 1-6 are for illustrative purposes only, and that many other sizes and shapes of the fire escape device 100 are well within the scope of the present disclosure. Although the dimensions of the fire escape device 100 are important design parameters for user convenience, the fire escape device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fire escape device that allows a user to escape a burning building quickly and efficiently, the fire escape device comprising:
a tube component; and
a plurality of foot platform components distributed throughout the tube component;
wherein the tube component extends down an outside of a building and is secured to the building;
wherein the plurality of foot platform components are attached to a cable that runs from a top of the tube component to a bottom of the tube component; and
further wherein the cable and the plurality of foot platform components utilize a pulley and counterweights to maintain a continuous operation of transporting users to the bottom of the tube component in an emergency.

2. The fire escape device of claim 1, wherein the tube component is a clear, thermoplastic, fireproof tube with a fireproof roof at the top.

3. The fire escape device of claim 2, wherein the tube component is installed within an interior of the building.

4. The fire escape device of claim 3, wherein the tube component comprises a series of access doorways provided along a side of the tube component, communicating with one of building floors so that users on all floors have access to the tube component for escape.

5. The fire escape device of claim 4, wherein the series of access doors each comprises an inclined opening, into which a user desiring to escape from the building places themselves to access a foot platform component, in a standing position.

6. The fire escape device of claim 5, wherein each of the series of access doorways is fitted with an upwardly pivotable door that automatically closes by gravity force when a user enters the tube component so that flames, suffocating gas and burning debris do not enter the tube component.

7. The fire escape device of claim 6, wherein upon entering the tube component, users will step onto a foot platform component and will slide down by a counterweight, thereby slowly lowering the user to an exit door at ground level.

8. The fire escape device of claim 7, wherein the cable extends from ground to the top of the tube component and will terminate at top and bottom with a pulley and cable system.

9. The fire escape device of claim 8, wherein the foot platform component is connected to the cable via a metal collet connected to a center part of the foot platform component which crimps the cable to hold the foot platform component in place on the cable.

10. The fire escape device of claim 9, wherein the cable and pulley comprise a conveyor part on which the users can stand, and a return part, wherein the foot platform components of the return part move below the foot platform components in the conveyor part and in an opposite direction in relation to them.

11. The fire escape device of claim 10, wherein both ends of the cable and pulley comprise an arrangement for turning direction of the foot platform components and for moving the foot platform components between the conveyor part and the return part.

12. The fire escape device of claim 11, wherein both ends of the cable and pulley comprise counterweights to give a mechanical advantage opposite the direction the user is pulling.

13. The fire escape device of claim 12, wherein the bottom of the tube component comprises an exit doorway with a latch mechanism, at street level which would permit escaped users to leave the fire escape device, and which would normally be locked from inside to prevent unauthorized users from the street from entering the building.

14. A fire escape device that allows a user to escape a burning building quickly and efficiently, the fire escape device comprising:
a tube component; and
a plurality of foot platform components distributed throughout the tube component;
wherein the tube component extends down an outside of a building and is secured to the building;
wherein the tube component comprises a series of access doorways provided along a side of the tube component, communicating with one of building floors so that users on all floors have access to the tube component for escape;
wherein the plurality of foot platform components are attached to a cable that runs from a top of the tube component to a bottom of the tube component and will terminated at top and bottom with a pulley and cable system;
wherein upon entering the tube component, users will step onto a foot platform component and will slide down by a counterweight, thereby slowly lowering the user to an exit door at ground level;
wherein the foot platform component is connected to the cable via a metal collet connected to a center part of the foot platform component which crimps the cable to hold the foot platform component in place on the cable;
wherein the cable and pulley comprise a conveyor part on which the users can stand, and a return part, wherein the foot platform components of the return part move below the foot platform components in the conveyor part and in an opposite direction in relation to them;
wherein both ends of the cable and pulley comprise an arrangement for turning direction of the foot platform components and for moving the foot platform components between the conveyor part and the return part;
wherein both ends of the cable and pulley comprise counterweights to give a mechanical advantage opposite the direction the user is pulling; and
further wherein the bottom of the tube component comprises an exit doorway with a latch mechanism, at street level which would permit escaped users to leave the fire escape device, and which would normally be locked from inside to prevent unauthorized users from the street from entering the building.

15. The fire escape device of claim 14 further comprising a plurality of electric lights for illuminating the fire escape device interior which automatically turn on when a user enters the fire escape device.

16. The fire escape device of claim 14 further comprising a plurality of indicia.

17. The fire escape device of claim 14, wherein the tube component is a clear, thermoplastic, fireproof tube with a fireproof roof at the top.

18. The fire escape device of claim 14, wherein the bottom of the tube component comprises an exit doorway with a latch mechanism, at street level which would permit escaped users to leave the fire escape device, and which would normally be locked from inside to prevent unauthorized users from the street from entering the building.

19. The fire escape device of claim 14, wherein each of the series of access doorways is fitted with an upwardly pivotable door that automatically closes by gravity force when a user enters the tube component so that flames, suffocating gas and burning debris do not enter the tube component.

20. A method of escaping a building fire from a large building, the method comprising the following steps:
providing a fire escape device comprising a tube with a plurality of foot platforms throughout, connected via a cable and pulley system and a large weight-resistant wheel;
entering the tube and stepping onto one of the foot platforms;
descending automatically via the cable and pulley system, such that the large weight-resistant wheel acts to slow the rate of descent; and
exiting the tube once the foot platform has reached the bottom of the building.
